(19) United States
(12) Patent Application Publication
(10) Pub. No.: US 2005/0202263 A1
(43) Pub. Date: Sep. 15, 2005

(54) Barrier layer to prevent the loss of additives in an underlying layer

(76) Inventors: Jonathan Sargent, Ann Arbor, MI (US); Holly Blaydes, Fenton, MI (US); Keith D. Weiss, Fenton, MI (US)

Correspondence Address: BRINKS HOFER GILSON & LIONE, P.O. BOX 10395, CHICAGO, IL, 60610, US

(21) Appl. No.: 10/938,164

(22) Filed: Sep. 10, 2004

Related U.S. Application Data
(60) Provisional application No. 60/551,930, filed on Mar. 9, 2004.

(51) Int. Cl. B32B 5/16; B32B 27/00

(52) U.S. Cl. 428/500; 428/323

(57) ABSTRACT

The present invention provides a protected layered system for a component assembly. The protected layered system includes a plastic panel and at least two protective layers formed integrally with the plastic panel. One protective layer is configured as a barrier layer that reduces the loss of an additive suspended, and not covalently bonded, in the structure of any underlying protective layer or the plastic panel. The weathering performance exhibited by the component assembly is similar for various colored or tinted plastic panels or protective layers.

### RELATED APPLICATIONS

This application claims the benefit of U.S. Provisional Application No. 60/551,930, filed on Mar. 9, 2004, the entire contents of which are incorporated herein by reference.

### TECHNICAL FIELD

This invention relates to a barrier layer that prevents the loss of an additive in underlying layers of a plastic panel for an automotive component assembly.

### BRIEF BACKGROUND OF THE INVENTION

Plastic materials, such as polycarbonate (PC) and polymethylmethyacrylate (PMMA), are currently being used in the manufacturing of numerous automotive parts and components, such as B-pillars, headlamps, and sunroofs. Automotive window modules represent an emerging application for these plastic materials because of various advantages in the areas of styling/design, weight savings, and safety/security. More specifically, plastic materials offer the automotive manufacturer the ability to reduce the complexity of the window assembly through the integration of functional components into the molded plastic module, as well as to distinguish their vehicle from a competitor's vehicle by increasing overall design and shape complexity. The use of light weight plastic window modules may facilitate both a lower center of gravity for the vehicle (better vehicle handling and safety) and improved fuel economy. Finally, enhanced safety is further recognized through a greater propensity for occupant or passenger retention within a vehicle having plastic window modules when involved in a roll-over accident.

Although many advantages associated with implementing plastic windows are recognized, these plastic modules will not see wide scale commercial utilization until existing regulations (e.g., Title 49, Chapter 5, Part 571.205 of the Federal Motor Vehicle Standard No. 205; ANSI-Z26.1 American National Standards Institute—1977) as established for glass windows are met. A summary of the minimum requirements established for using plastic windows in an automobile is provided in Table 1.

TABLE 1

| | Requirement |
|---|---|
| Abrasion Resistance | ≦2.0 in front of B-pillar; |
| (Δ % haze) | ≦10.0 behind the B-pillar |
| Optical Transmission | ≧90.0% clear, |
| (%) | ≧70.0 solar, |
| | ≧20% privacy |
| Initial Haze (%) | ≦1.0 |
| Coating Adhesion | 100 |
| Retention (%) | |
| Lifetime | >5 |
| (years in Florida | |
| or Arizona) | |
| Color Change (Δ YI) | <2.0 |
| Impact Resistance | Ductile |

In order to meet the requirements as specified in Table 1, protective layers (e.g., coatings or films) must be applied to the plastic window module to overcome several limitations exhibited by plastic materials. These limitations include degradation caused by exposure to ultraviolet (UV) radiation as exemplified by a color change, decreased optical transmission, and enhanced embrittlement (decrease in impact resistance), as well as both limited abrasion resistance and hydrolytic stability. Premature failure of the protective layer system as indicated by delamination or adhesion loss will result in a limited lifetime for the plastic window module via the acceleration of the aforementioned degradation mechanisms. Differences in the color or tint of the plastic window, for example, transparent clear, solar (green), and privacy (black), can facilitate premature failure of the protective layer system, presumably through an increase in the temperature of the interface between the plastic window and the protective layer system during environmental exposure. This same argument can be applied to the failure mechanism observed for other opaque plastic components (e.g., molding, B-pillars, tailgate modules, body panels, etc.) of various colors.

Therefore, there is a need in the industry to develop a protective layer system that will allow a plastic window module to meet automotive regulatory requirements for windows and to be robust against the occurrence of premature failure.

### BRIEF SUMMARY OF THE INVENTION

The present invention provides a protective layered system for a component assembly. The layered system includes at least one layer acting as a barrier towards the leaching or loss of additives not bonded into the structure of any underlying protective layer or the plastic panel substrate. The performance of the layered system is substantially independent of the color or tint of the plastic panel or additive layers. The plastic panel and additive layers may be transparent, opaque, or a mixture thereof.

In certain embodiments, the component assembly is a window assembly that includes a transparent plastic panel, optional protective additive layers, and a barrier layer whose properties meet the performance requirements for use in an automotive application.

Other features and advantages will become apparent upon considering the following detailed description and appended claims, and upon reference to the accompanying drawings.

### BRIEF DESCRIPTION OF THE DRAWINGS

FIG. 1 is a graphical representation for several of the possible geometries of a protected layered structure of a component assembly with a plastic panel, additive layer, and a barrier layer in accordance with the invention.

FIG. 2 is a graphical representation of the UV absorbance exhibited by a plastic panel and additive layer system both with and without the presence of a barrier layer plotted as a function of the overall amount of UV radiation.

FIG. 3 is a graphical representation of the UV absorbance exhibited by a plastic panel and additive layer system both with and without the presence of a barrier layer plotted as a function of the overall time (hours) when exposed to a temperature of about 70° C.

### DETAILED DESCRIPTION OF THE INVENTION

The following description of the preferred embodiment is merely exemplary in nature and is in no way intended to limit the invention or its application or uses.

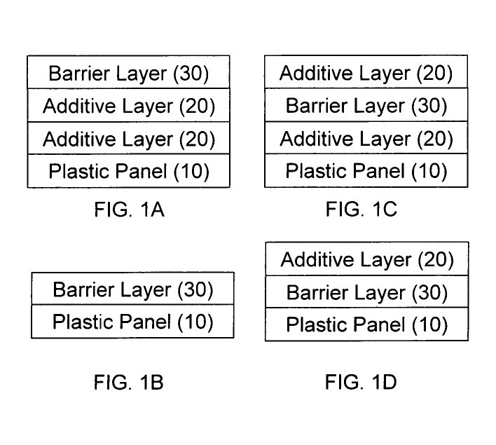

In accordance with the invention, a protective layered system increases the life-time of a plastic component assembly when one layer acts as a barrier against the leaching or loss of additives from within any underlying additive layers and the plastic panel. Several of the possible geometric configurations for the structure of the protective layered system are provided in FIG. 1. The barrier layer 30 (“B”) may be the outermost layer that acts as a barrier against additive leaching from any underlying additive layers 20 and/or the plastic panel 10 as shown in FIGS. 1A and 1B. The barrier layer 30 may also be sandwiched between additive layers 20 and the plastic panel 10 to act as a barrier against additive leaching from only the underlying additive layer 20 or the plastic panel 10 as represented in FIGS. 1C and 1D. In a particular implementation, the barrier layer 30 is the outermost layer in order to provide the additional benefit of abrasion resistance for the component assembly. The component assembly may contain multiple additive layers, as well as multiple barrier layers.

In order to demonstrate the barrier effect and compare the performance exhibited by various plastic panels 10 and additive layers 20 both with and without a barrier layer 30, several specific plastic resins (R1-R6), additive layers (A1-A9), and barrier layers (B1-B2) were selected as identified in Table 2. These resins and additive layers along with two of the possible barrier layers 30 should not be construed to limit the scope of the invention, but merely to illustrate various implementations of the invention. The nomenclature used to identify the composition of the protective layered systems selected to demonstrate the barrier effect provides individual labels for the specific plastic resins, additive layers, and barrier layers as described in Table 2. For instance, a protective layered system identified as R2+A2A7 includes a plastic resin panel R2 and additive layers A2 and A7. A protective layered system identified as R1+A8+B1 includes a plastic resin panel R1, an additive layer A8, and a barrier layer B1.

Conventional barrier coatings attempt to prevent molecules, such as water or oxygen, from transuding through the coating from the environment into the coated substrate. These environmental contaminants are typically small in size with a molecular diameter of less than 150 picometers (i.e., the molecular diameter of O₂˜121 picometers, and the molecular diameter of H₂O˜108 picometers). However, the barrier layer 30 may be permeable to such molecules that arise in the environment. For instance, in a particular embodiment a barrier layer 30 at about 37.8° C. and about 100% relative humidity allowed a transmission rate for water vapor of about 3.7 gms per m²-day (Permatran W 3/31, MOCON, Minneapolis, Minn.).

TABLE 2

| | SUBSTRATE RESIN | MANUFACTURER |
|---|---|---|
| R1 | Clear Polycarbonate | LS2, GE Plastics, Mount Vernon, Indiana USA or |
| | | AL2647, Bayer AG, Germany |
| R2 | Clear Polycarbonate | M2808, Bayer AG, Germany or 101-111N, GE |
| | | Plastics, Mount Vernon, Indiana USA |
| R3 | Solar Tinted (Green) | LS2, GE Plastics, Mount Vernon, Indiana USA or |
| | Polycarbonate | AL2647, Bayer AG, Germany |
| R4 | Grey Colored (Solar) | R2 + grey background (plaque) |
| | Polycarbonate | |
| R5 | Privacy Tinted (Black) | LS2, GE Plastics, Mount Vernon, Indiana USA or |
| | Polycarbonate | AL2647, Bayer AG, Germany |
| R6 | Black Colored (Privacy) | R2 + black background (ink or plaque) |
| | Polycarbonate | |
| | ADDITIVE LAYER | MANUFACTURER |
| A1 | Acrylic | Exatec ® SHP-9X, Exatec LLC, Wixom, Michigan |
| | | USA |
| A2 | Acrylic | SHP401, GE Silicones, Waterford, New York USA |
| A3 | Acrylic | UVHC3000, GE Silicones, Waterford, New York |
| | | USA |
| A4 | Acrylic | SHP470, GE Silicones, Waterford, New York USA |
| A5 | Acrylic | PR-800, SDC Technologies, Inc., Anaheim, CA |
| | | USA |
| A6 | Silicone Hard-coat | Exatec ® SHX, Exatec LLC, Wixom, Michigan USA |
| A7 | Silicone Hard-coat | AS4000, GE Silicones, Waterford, New York USA |
| A8 | Silicone Hard-coat | PHC587, GE Silicones, Waterford, New York USA |
| A9 | Silicone Hard-coat | MP-101, SDC Technologies, Inc., Anaheim, CA |
| | | USA |
| | BARRIER LAYER | MANUFACTURER |
| B1 | Si_{w}OₓC_{y}H_{z} applied by | Exatec LLC, Wixom, Michigan USA |
| | Plasma Enhanced | |
| | Chemical Vapor Deposition | |
| B2 | Silicone Hard-coat | AS4700, GE Silicones, Waterford, New York USA |

Conventional barrier coatings are permeable to large molecules diffusing through the coating from underlying coating layers or the substrate into the environment. Barrier coatings used in microelectronic fabrication allow the diffusion of polymeric decomposition products through a barrier coating into the environment. For example, in order to form an air gap between conductive metallic lines during microelectronic fabrication, the high molecular weight decomposition products of polynorbornene readily diffuse through an overlying dielectric (barrier) coating into the surrounding environment.

The barrier layer 30 was found unexpectedly to reduce or prevent the leaching of additives greater than 150 picometers in molecular diameter from underlying additive layers and the plastic panel through the barrier layer into the environment. Preferably, the barrier layer 30 reduces or prevents the leaching of additives with a molecular diameter greater than about 200 picometers, or in certain implementations, greater than about 300 picometers.

Preventing the leaching of additives from the plastic panel and any additive layers increases the associated life-time of the component assembly. The life-time of a component assembly is measured according to the magnitude of the changes in performance observed in the color (yellowing index=YI) and the impact resistance characteristics as described in Table 1. Primarily, a plastic panel exhibiting a change in the yellowing index (YI) in excess of about +5 units or beginning to show signs of impact failure (e.g., caused by embrittlement) is considered to have reached the useful life-time of the component assembly.

Most plastics materials are susceptible to degradation via photochemical-driven processes. Typically, these degradation processes lead to the formation of molecular species that may affect either the color characteristics or the impact resistance of the plastic material. Protection against these photochemical-driven processes is usually accomplished by the incorporation of ultraviolet absorbing (“UVA”) molecules into either the bulk plastic material or an additive layer applied to the surface of the plastic material. When the UVA molecules are applied in a protective additive layer, the delamination or loss of adhesion between this additive layer and the plastic panel is considered to be a failure resulting in a limitation to the useful life-time associated with the component assembly.

The type and concentration of the UVA molecules in a protective additive layer inherently dictates the useful life-time for the component assembly. UVA molecules over time may reach a photochemical inactive stage or be present in a concentration that is not large enough to entirely stop the occurrence of the photochemical-driven degradation mechanisms. The interface between the additive layer and the plastic material represents the area that will be initially degraded by any UV radiation not absorbed by the UVA molecules present in the additive layer. Since degradation of this interface will facilitate the delamination of the additive layer, the failure of the additive layer is highly dependent upon the concentration and life-time of the UVA molecules incorporated into the additive layer. In accordance with the invention, an increase in the yellowing index (YI) of greater than +5 units for the plastic panel has been found to coincide with the delamination of the protective additive layer, as well as the onset of embrittlement.

The amount of UV radiation exposure (UV_{EXP}) necessary to reach either a change in color (ΔYI) of +5 units and delamination of the additive layer or to cause impact failure can be predicted using Equation 1 below. In this equation D refers to the rate of decay, A_{O} refers to the initial measured absorbance value, and T_{F} refers to the amount of radiation that will cause the indicated color change or impact failure in an “unprotected” plastic panel. The amount of ultraviolet radiation exposure (UV_{EXP}) as determined by using this equation is given in Megajoules (MJ). The value of T_{F} is easily determined by experimentally measuring the color change or impact properties in an “unprotected” plastic panel as a function of radiation exposure.
UV_{EXP}=(1/D)log [(10^{(DT}^{_{F}}⁾+10^{(-A}^{_{O}}⁾−1) /10^{(-A}^{_{O}}⁾) ] (1)

In accordance with the invention, the barrier layer 30 increases the amount of UV radiation to which a plastic panel can be subjected by about 63% prior to a failure as indicated by a color change (i.e., ΔYI) in excess of +5 units. A polycarbonate (R2) panel protected by additive layers (A2A7), which contain UVA molecules, was found to reach a change in the Yellowing Index (ΔYI) of +5 units upon exposure to 8 MJ of ultraviolet radiation (see Trial #01, Table 3). In comparison, the same plastic panel (R2+A2A7) was found to reach a change in YI of +5 units upon exposure to greater than about 12 MJ of ultraviolet radiation when a barrier layer 30 encapsulated the protective additive layers containing the UVA molecules (Trial #02, Table 3). As shown in Table 3 the actual measured time to failure for the panel was found to compare very closely to the predicted time to failure calculated from Equation 1.

TABLE 3

| | | Δ(YI) ≧ +5 units | Δ(YI) ≧ +5 units |
|---|---|---|---|
| | | MEASURED | CALCULATED EQ. 1 |
| | | (Megajoules) | (Megajoules) |
| #01 | R2 + A2A7 | 8.0 | 8.9 |
| #02 | R2 + A2A7 + B1 | 13.0 | 12.5 |
| | Barrier Effect | 62.5% | 40.4% |

In accordance with the invention, the barrier layer 30 increases the amount of UV radiation to which a plastic panel can be subjected by about 42% prior to reaching “embrittlement” or failure in impact resistance. A plastic panel (R2) protected by only additive layers (A2A7), which contained UVA molecules, was found to reach the point of failure with respect to impact resistance upon exposure to 10.3 MJ of ultraviolet radiation. In comparison, the same plastic panel (R2+A2A7) was found to reach the point of failure with respect to impact resistance upon exposure to about 14.6 MJ of ultraviolet radiation when a barrier layer 30 encapsulated the protective additive layers.

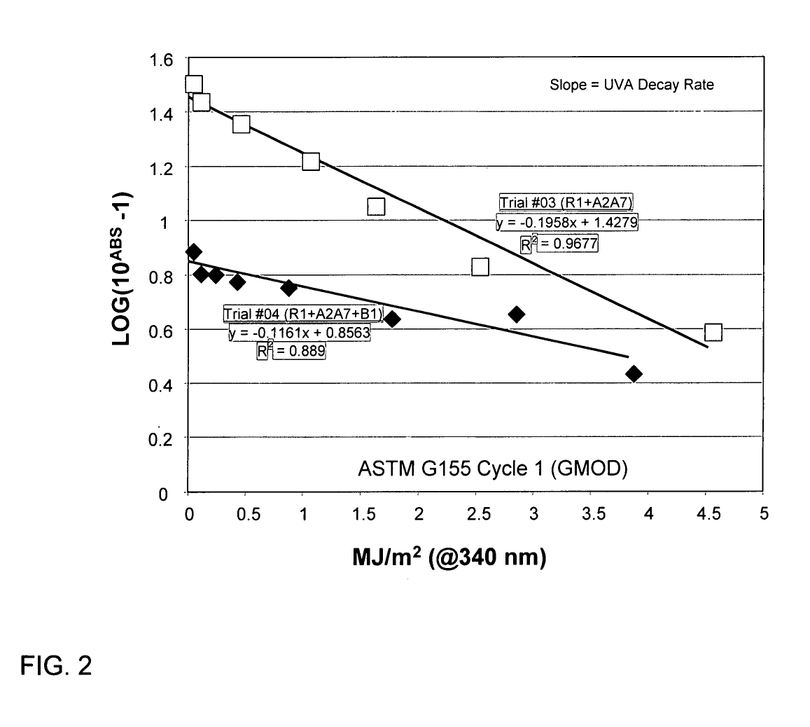

Further in accordance with the invention, the barrier layer 30 reduces the rate of decay for an additive in a protective layered system by more than about 20%. For example, the rate of decay relative to the UV absorbance exhibited by the UVA molecules present in an additive layer dramatically decreases upon the use of a barrier layer as defined here. In this case, the rate of decay (D) is defined as the decrease in the number of absorption (ABS) units measured for the UVA molecules in the additive layers per Megajoule (MJ) of UV radiation (wavelength=340 nm) to which the panel or window assembly is exposed. A plastic panel (R1) protected by additive layers (A2A7), which contain UVA molecules, was found to exhibit a rate of decay for the UVA molecules upon exposure to UV radiation equal to about −0.20 ABS/MJ exposure as shown in FIG. 2 (see Trial #03). In comparison, the same plastic panel (R1+A2A7) was found to exhibit a rate of decay equal to about −0.11 ABS/MJ when a barrier layer 30 encapsulated the protective UVA molecule containing additive layers (see Trial #04). Thus the application of a barrier layer 30 over UVA molecule containing additive layers reduced the rate of decay in this specific case by about 41%.

In accordance with the invention, the barrier layer 30 was discovered unexpectedly to allow opaque plastic panels and transparent plastic windows containing different colorants and tints, respectively, to perform similarly. In other words, the performance of a tinted or colored plastic panel and additive layer combination is normalized when a barrier layer is utilized. The rate of decay for UVA molecules in protective additive layers (A2A7or A1A6) on plastic panels (R2, R4, R6) that are characterized as being clear (>90% transparency), solar grey, and privacy black, respectively, were measured both with and without the presence of a barrier layer 30. The rate of decay (D) for the UVA molecules in the protective additive layers in the absence of a barrier layer was found to follow the trend of D_{CLEAR}>D_{SOLAR}>D_{PRIVACY}. For example, when a plastic panel was coated with only protective additive layers (A1A6) the rate of decay was measured to range from 0.03 to 0.05 ABS/MJ for clear to privacy colored panels, respectively. The dependence of UV absorbance decay rate on the color or tint of the protective layered system may be related to the difference in the surface temperature experienced by the plastic panel. For example, a 20° C. difference exists between clear and privacy colored panels undergoing an accelerated weathering test, ASTM G155, Cycle 1 (GMOD). In this particular test, the temperature of the clear and privacy panels were found to be 70° C. and 90° C., respectively. In accordance with various implementations of the present invention, the barrier layer allows the lifetime of plastic panels to be substantially similar when the surface temperature of the plastic panels is between about 20° C. and about 120° C.

When a barrier layer 30 is applied over the protective additive layers, the rate of decay (D) was found to follow the trend D_{CLEAR}˜D_{SOLAR}˜D_{PRIVACY}. For example, when the plastic panel was coated with protective additive layers (A1A6) and a barrier layer B1, the rate of decay was measured to be about 0.02 ABS/MJ for all (clear to privacy) colored panels. In all cases, the rate of decay was reduced by more than about 20% upon the use of a barrier layer 30, as shown in Table 4. The barrier layer 30 effectively reduces the affect that the surface temperature of the plastic panel has on the decay rate for the UV absorbance by the protective layered system.

TABLE 4
Decrease in UVA Decay Rate

| | | |
|---|---|---|
| #05 | R2 + A2A7 + B1 | 22% |
| #06 | R4 + A2A7 + B1 | 27% |
| #07 | R6 + A2A7 + B1 | 27% |
| #08 | R2 + A1A6 + B1 | 42% |
| #09 | R4 + A1A6 + B1 | 75% |
| #10 | R6 + A1A6 + B1 | 40% |

Further in accordance with the invention, the barrier properties exhibited by the barrier layer 30 can be determined by measuring the relative loss of the additive with respect to exposure time at an elevated temperature. The barrier layer prevents the loss of an additive to less than about 0.15% after 100 hours exposure to 70° C., preferably about 0.50% after 300 hours, or more preferably about 0.80% after 500 hours. Specific properties of the additive can be monitored as a function of time to determine the relative loss of the additive. For example, when the additive is an UVA molecule, the loss in absorption units for the UVA as a function of the time (hours) exposed to a temperature of 70° C. can measured to determine the relative loss. The barrier layer 30 was found in this specific case to prevent the loss of the UVA molecule from underlying additive layers (A2A7) and the plastic panel (R2) to less than 0.157%, 0.470%, and 0.780% after about 100, 300, and 500 hours exposure at about 70° C., respectively (see Trial #16, Table 5). Overall, the barrier layer 30 reduces the rate of additive loss in underlying additive containing layers and the plastic panel by more than about 300%.

The plastic panel 10 may include any thermoplastic or thermoset polymeric resin. The plastic panel may be opaque, transparent or a mixture thereof. The polymeric resins may include but are not limited to polycarbonate, acrylic, polyarylate polyester, polysulfone, polyurethane, silicone, epoxy, polyamide, polyalkylenes, and acrylonitrile-butadiene-styrene (ABS), as well as copolymers, blends, and mixtures thereof. The preferred transparent, thermoplastic resins include but are not limited to polycarbonate resins, acrylic resins, polyarylate resins, polyester resins, and polysulfone resins, as well as copolymers and mixtures thereof. The plastic panel may further include various additives, such as colorants, rheological control agents, mold release agents, antioxidants, ultraviolet absorbing (UVA) molecules, and IR absorbing or reflecting pigments, among others. The plastic panels may be formed into a component assembly through the use of any known technique to those skilled in the art, such as extrusion, molding, which includes injection molding, blow molding, and compression molding, or thermoforming, which includes thermal forming, vacuum forming, and cold forming.

The additive layers 20 may include but are not limited to silicones, polyurethanes, acrylics, polyesters, epoxies, and mixtures or copolymers thereof. The additive layers may be extruded or cast as thin films or applied as a discrete coating. Multiple additive containing coating layers include either an acrylic primer and silicone hard-coat or a polyurethane interlayer may be used to enhance the protection of the plastic panel. An example of multiple additive coating layers include a combination of an acrylic primer (SHP401, GE Silicones, Waterford, N.Y.) and a silicone hard-coat (AS4000, GE Silicones). The additives in the additive layer may be colorants (tints), rheological control agents, mold release agents, antioxidants, ultraviolet absorbing (UVA) molecules, and IR absorbing or reflecting pigments, among others. Additive coating layers may be applied by dip coating, flow coating, spray coating, curtain coating, or other techniques known to those skilled in the art. Additive thin film layers may be applied by in-mold decorating, film insert molding, casting, or other techniques known to those skilled in the art.

The additives whose loss is preferably controlled by the use of a barrier layer 30 include ultraviolet absorbing (UVA) molecules among others. The UVA molecules may include, but are not limited to, derivatives of hydroxybenzophenone, polybenzoylresorcinol, or combinations thereof, as well as 2-ethylhexyl-2-cyano-3,3-diphenylcyanoacrylate. If the UVA molecules are silylated in order to bind the UVA molecules into the coating network, the proportion of the UVA molecules present as an additive that can not be bonded into the network for the barrier layer to have a substantial effect is preferably on the order of about 5%.

The barrier layer 30 may include any known conductive or dielectric materials with inorganic dielectric materials, organic dielectric materials, or mixtures and blends thereof being preferred. Examples of inorganic dielectric materials include but are not limited to aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof. Organic dielectric materials may include but are not limited to diamond-like carbon and “dense” polymer systems, such as urethanes, epoxides, acrylates, silicones, and mixtures or blends thereof. A polymer system is considered to be a “dense” polymer system if it meets the performance criteria established for a barrier layer 30 as defined here.

The barrier layer 30 may be applied by any suitable technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include but are not limited to plasma enhanced chemical vapor deposition, ion assisted plasma deposition, magnetron sputtering, electron beam evaporation, and ion beam sputtering. Examples of atmospheric coating processes include but are not limited to curtain coating, spray coating, spin coating, dip coating, and flow coating.

Examples of a protective layered system with a plastic panel, two additive coating layers and a barrier layer 30 include polycarbonate/acrylic/silicone/“glass-like” systems. In these systems, the polycarbonate represents a transparent plastic panel, the acrylic and silicone interlayers represent two additive layers 20, while the “glass-like” outer most layer represents the barrier layer 30.

The thickness of the barrier layer 30 may range from about 1 micrometer to about 100 micrometers. The optimum thickness of the barrier layer 30 depends upon the effectiveness of this layer in preventing the loss of additives from underlying layers and on the optical properties exhibited by the layer. The overall window assembly with the transparent plastic panel, any additive layers, and the barrier layer 30 preferably meets the optical requirements with respect to haze and light transmission as specified in Table 1. Likewise the thickness of the additive layers may range from about 1 micrometer to about 100 micrometers, depending upon their optical properties and effect on the performance of the overall window assembly.

The following specific examples are provided to illustrate the invention and should not be construed to limit the scope of the invention.

### EXAMPLE 1

### Sample Preparation

Flat panels were molded using either a commercially available polycarbonate resin (LS2, GE Plastics, Mount Vernon, Ind. or AL2647, Bayer AG, Germany) or a specialty version of this resin (M2808, Bayer AG, Germany or 101-111N, GE Plastics, Mount Vernon, Ind., USA) formulated to exhibit a UV absorption spectrum of less than about 1 absorption unit (ABS) in the wavelength range of 315-360 nanometers. Each type of resin used to mold the plastic panels is further identified in Table 2 as R1 through R6.

The polycarbonate resin used to form each panel was either clear (R1 and R2), tinted (R3 and R5), or colored (R4 and R6). The resin in the tinted panels contained a color additive or colorant, thereby producing a panel tinted to that color. The colored panels were prepared by either printing a colored ink or adhering a colored film (e.g., plaque) to the back side of a clear (R1 and R2) panel.

The prepared panels were then coated with one or more additive coating layers as described in Table 2 as A1 through A9. After the application of each additive coating layer, the coating was allowed to “flash” or air dry for 20-30 minutes prior to being thermally cured for about 30-60 minutes at about 110-130° C. The commercially available coating was applied and cured according to the manufacturer's recommended conditions.

One-half of the panels coated with each additive layer or combination of additive layers was then subjected to the application of a barrier layer 30, the nature of which is described in Table 2. The barrier layer 30 was applied or deposited to the surface of the outermost additive layer according to the conditions and parameters described in an article published by M. Schaepkens, S. Selenzneva, P. Moeleker, and C. D. Iacovangelo in Journal Vacuum Science and Technology A, 21(4), 2003, pgs 1266-1271, the entire contents of which are incorporated herein by reference.

All of the panels molded from various resins (R1-R6) and coated with various additive layers (A1-A9) both with or without the application of a barrier layer 30 were then used in subsequent Examples for the evaluation of the barrier effect. All of the transparent panels prepared in this Example were ductile in nature and met both the optical transmission (%) and initial haze (%) requirements as defined in Table 1.

### Example 2

### Barrier Effect: Thermal Loss

A portion of the panels prepared in Example 1 were exposed to heat in a convection oven at 70° C. Each panel was inspected using a spectrometer after being exposed to the elevated temperature for 0, 24, 72, 144, 312, 648, 1008, 1368, and 1728 hours. The spectroscopic examination was made using a Cary 500 scan UV-Vis-NIR Spectrometer (Varian, Palo Alto, Calif.) in the wavelength range of 215-500 nanometers at a scanning rate of 300 nanometers per minute.

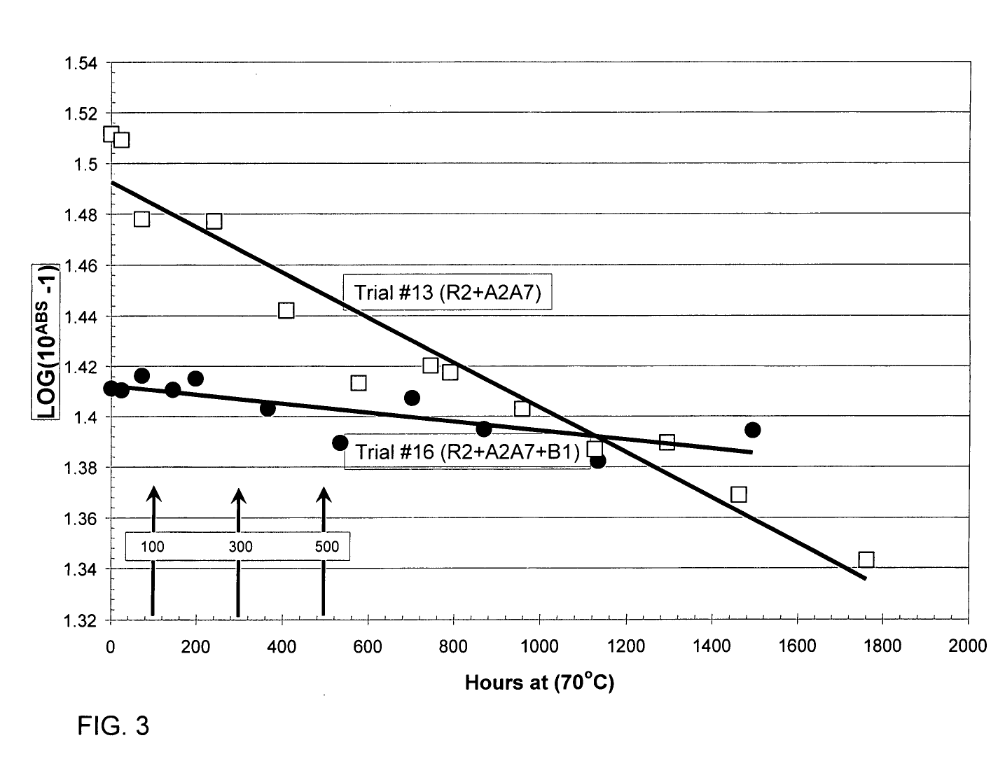

A plot of the log of ten to the power of the UV absorbance minus 1 (Log [10^{ABS}−1]) versus the length of time exposed to 70° C. was obtained for each panel evaluated. An example of such a plot is shown in FIG. 3 for the two panels identified as R2+A2A7 (Trial #13) and R2+A2A7+B1 (Trial #16). Linear regression curve fit analysis was used to obtain the slope and y-intercept for each panel evaluated. The slope of the line represents the rate of additive (UVA molecules) loss in units of ABS per hour. At certain specific time intervals, the percentage of additive loss is then calculated and compared for identical resin and additive layer systems in the presence and absence of a barrier layer 30.

The rate of additive loss and the percentage of additive loss as a function of time were determined for multiple additive layer systems with and without the application of a barrier layer 30 as shown in Table 5. The various additive layer combinations (Trial #'s 11-13) without the application of the barrier layer 30 was determined to decrease its ability to absorb UV radiation by about 0.3 to 0.6% after exposure to 70° C. for 100 hours; about 0.9 to 1.8% after 300 hours; and about 1.4 to 3.0% after about 500 hours. The rate of additive absorption loss for these various additive layer combinations (Trial #'s 11-13) ranged from 1.0×10⁻⁴ to 8.9×10⁻⁵ ABS/hour.

In comparison, the same additive layer combinations in the presence of a barrier layer 30 (Trial #'s 14-16) were found to exhibit a significant reduction in the additive loss rate. The various additive layer combinations (Trial #'s 14-16) with the application of the barrier layer 30 was determined to decrease its ability to absorb UV radiation by about 0.05 to 0.2% after exposure to 70° C. for 100 hours; about 0.2 to 0.5% after 300 hours; and about 0.3 to 0.8% after 500 hours. The rate of additive absorption loss for these various additive layer combinations with a barrier layer 30 (Trial #'s 14-16) ranged from 1.0×10⁻⁵ to 2.0×10⁻⁵ ABS/hour. The overall effect of the barrier layer 30 in this specific example (see FIG. 3) is to enhance the ability of the additive (UVA molecules) layers in the presence of the barrier layer (Trial #'s 14-16) to absorb UV radiation by greater than 300% when compared to the same system without a barrier layer (Trial #'s 11-13) after exposure to an elevated temperature for a specified amount of time.

TABLE 5

| | | | Slope of |
|---|---|---|---|
| | | | Linear |
| ABS Loss (%) as Function | | | Regression |
| of Time (hrs) @ 70° C. | | | Curve Fit |
| 100 hours | 300 hours | 500 hours | (ABS/hour) |

Additive Layers

| | | | | |
|---|---|---|---|---|
| #11 R2 + A5A9 | 0.280% | 0.860% | 1.400% | −0.0001000 |
| #12 R2 + A1A6 | 0.196% | 0.588% | 0.980% | −0.0000700 |
| #13 R2 + A2A7 | 0.598% | 1.790% | 2.989% | −0.0000891 |

Plus Barrier Layer

| | | | | |
|---|---|---|---|---|
| #14 R2 + A5A9 + B1 | 0.050% | 0.160% | 0.267% | −0.0000200 |
| #15 R2 + A1A6 + B1 | 0.000% | 0.000% | 0.000% | −0.0000100 |
| #16 R2 + A2A7 + B1 | 0.157% | 0.470% | 0.780% | −0.0000179 |

BARRIER EFFECT

| | | | |
|---|---|---|---|
| #11 versus #14 | 560% | 538% | 524% |
| #12 versus #15 | >1000% | >1000% | >1000% |
| #13 versus #16 | 381% | 381% | 383% |

This Example demonstrates that the barrier layer 30 prevents the loss of an additive to less than about 0.15% after 100 hours exposure at 70° C., preferably about 0.50% after about 300 hours, and more preferably about 0.80% after about 500 hours. This Example further demonstrates the ability of a barrier layer 30 to perform similarly for different underlying additive layers (e.g., A1A6, A2A7, and A5A9).

### EXAMPLE 3

### Barrier Effect: Rate Loss (ABS/MJ)

A portion of the panels prepared in Example 1 were exposed to UV-visible light in several different natural and accelerated weathering tests. In one such test, the panels (Trial #'s 17-24) were subjected to UV-visible light in an Atlas C5000i weatherometer, using the ASTM G155 Cycle 1 (GMOD) artificial weathering protocol using the following specific conditions: (1) The UV source was a Xenon Arc having a borosilicate inner and borosilicate outer filter with a spectral intensity of 0.75 W/m² at 340 nm; (2) A black panel temperature of 75° C.; (3) A relative humidity of 30%; and (4) A dry bulb temperature of 55° C. All panels were examined for the occurrence of microcrazing, spontaneous delamination, or adhesion failure using ASTM D 3359-92a after every 1.2 MJ/m² of UV exposure. Upon failure the panels were removed from testing.

Another portion of the panels (Trial #'s 25-28) prepared in Example 1 were exposed to outdoor natural weathering in both Florida and Arizona at a 5° angle. Each panel was examined every 6 months for the occurrence of microcrazing, spontaneous delamination, or adhesion failure using ASTM D 3359-92a. Upon failure the panels were removed from testing.

Another portion of the panels (Trial #'s 25-28) prepared in Example 1 were exposed to accelerated outdoor weathering in Arizona using ASTM G90 Cycle 3 (ASTM D4141) at a QTRAC (Q-PANEL, Cleveland, Ohio) facility. Each panel was examined every 6 months for the occurrence of microcrazing, spontaneous delamination, or adhesion failure using ASTM D 3359-92a. Upon failure the panels were removed from testing.

Finally, another portion of the panels prepared in Example 1, as well as the uncoated resin (R1-R6) panels were exposed to UV-Visible light using a QUV spray weatherometer, (Q-Panel Lab Products, Cleveland, Ohio). The ASTM G154 Cycle 4 artificial weathering protocol was used for this test with one modification. This modification consisted of continuously exposing the panels to a spectral intensity of 1.35 W/m² at a 340 nm wavelength using florescence lamps. All panels were examined both visibly and spectroscopically for weathering damage (e.g., microcrazing and coating delamination) after 0, 24, 72, 144, 312, 648, 720, and 1440 hours of exposure.

Spectroscopic examination of the panels were made using a Cary 500 scan UV-Visible-NIR Spectrometer (Varian, Palo Alto, Calif.) in the wavelength range of 215-500 nm at a scanning rate of 300 nm/min. A yellowness index was determined, using ASTM E313-00, Standard practice for calculating yellowness and whiteness indices from instrumentally measured color coordinates, using a BYK Color-Guide (Color System: CIE Lab; Index: YE 313-98, Illumination/Observer: D65/10°).

The yellow index of the uncoated (no additive layers) polycarbonate panel was plotted versus the measured absorption (ABS) change at a wavelength of 340 nm, caused by UV radiation exposure. A linear regression curve fit applied to this plot yielded a slope which was used as a photo-Fries correction factor. This correction factor was used to determine the corrected absorbance at 340 nm due to loss of the UVA molecules in panels including polycarbonate resin and various additive layers. Plots of the log of ten to the power of the absorbance minus 1 (i.e., Log [10^{ABS}−1]) using the corrected absorbance values versus the amount of UV radiation exposure (MJ/m²) were constructed for each panel evaluated. An example of such a plot is shown in FIG. 2 for both a panel identified as R1+A2A7(Trial #03) and a panel identified as R1+A2A7+B1 (Trial #04). The decay rate or absorption loss rate (ABS/MJ) is defined as the slope of the linear curves obtained from this analysis.

Finally, the abrasion resistance of another portion of the panels (Trial #'s 17-24) prepared in Example 1 was tested according to ASTM D1044 (1000 cycles, CSF10 wheels).

The test results obtained for the panels prepared in Example 1 after exposure to the various accelerated and natural weathering conditions described above are provided in Table 6. A direct comparison between panels with a polycarbonate resin (R3) and various additive layers, such as A1A6 (Trial #17), A2A7 (Trial #'s 18 and 25), A8 (Trial #'s 21 and 27), and A3 (Trial #23), with and without the addition of a barrier layer (see Trial #'s 18, 20, 22, 24, 26, and 28) was made. This example demonstrates that the presence of a barrier layer 30 will significantly enhance the stability of the additive layers and resin panel under weathering conditions.

TABLE 6

| | ASTM G155 Cycle 1 (GMOD) | | | |
|---|---|---|---|---|
| | | | | Delta Haze % |
| | Failure | Additive Layer | Absorption | (Taber, 1000 |
| | (MJ/m² @ | Thickness | Loss Rate | cycles, CSF10 |
| | 340 nm) | (micrometers) | (ABS/MJ @ 340 nm) | wheels) |
| #17 R3 + A1A6 | 5.0 | 7.3 | −0.03 | 12% |
| #18 R3 + A1A6 + B1 | 13.8 | 7.2 | −0.02 | 2% |
| #19 R3 + A2A7 | 8.6 | 4.9 | −0.20 | 10% |
| #20 R3 + A2A7 + B1 | 12.9 | 4.7 | −0.12 | 2% |
| #21 R3 + A8 | 4.9 | 4.2 | −0.24 | 8% |
| #22 R3 + A8 + B1 | 5.4 | 4.2 | −0.11 | 1% |
| #23 R3 + A3 | 6.5 | 7.0 | −0.54 | 20% |
| #24 R3 + A3 + B1 | 7.0 | 7.4 | −0.07 | 1% |

| | ASTM G90 Cycle 3 (QTRAC) | | Florida Natural Weathering | | Arizona Natural Weathering | |
|---|---|---|---|---|---|---|
| | | Additive Layer | | Additive Layer | | Additive Layer |
| | Failure (MJ/m² | Thickness | | Thickness | | Thickness |
| | TUVR) | (micrometers) | Failure (years) | (micrometers) | Failure (years) | (micrometers) |
| #25 R3 + A2A7 | 836 | 6.3 | 1.5 | 7.6 | 2.0 | 6.2 |
| #26 R3 + A2A7 + B1 | 1704 | 6.4 | 2.5 | 7.7 | 3.5 | 6.2 |
| #27 R3 + A8 | 570 | 4.4 | 2.0 | 4.5 | 1.5 | 4.4 |
| #28 R3 + A8 + B1 | 710 | 4.6 | 2.5 | 4.6 | 2.5 | 4.4 |

| | ASTM G154, Cycle 4 (QUVA) |
|---|---|
| | Decrease in Absorption Loss |
| | Rate (% Δ ABS/MJ @ 340 nm) |
| #29 R3 + A2A7 + B1 | 40% |
| #30 R3 + A8 + B1 | 50% |
| #31 R3 + A4 + B2 | 27% |
| #32 R3 + A4 + B2B1 | 71% |

The presence of a barrier layer 30 increased the amount of UV radiation (MJ/m²) to which a panel could be exposed during ASTM G155 Cycle 1 (GMOD) testing. This increase correlates directly to an increase in the lifetime of the transparent panel or window in actual use. This increase ranged from about 10% (compare Trial #21 to #22 and #23 to #24) to greater than 50% (compare Trial #17 to #18 and #19 to #20). Similarly, the absorption loss rate for each panel during UV exposure was reduced when the barrier layer 30 was present. This reduction in loss rate (ABS/MJ) was found to be greater than about 30% for all of the additive systems evaluated in the presence of a barrier layer 30 (compare Trial #21 with #22, #23 with #24, #17 with #18, and #19 with #20). The thickness of the additive layers for the panels in each comparison made during the analysis was approximately comparable, thereby, eliminating the possibility that a greater amount of additive being present could account for the observed performance differences. For instance, the thickness for the additive layers on the panel in Trial #17 (7.3 μm) is similar to the thickness of the additive layers on the panel in Trial #18 (7.2 μm).

The presence of a barrier layer 30 increased the amount of UV radiation to which a panel could be exposed during ASTM G90, Cycle 3 (QTRAC) testing, Florida Natural Weathering, Arizona Natural Weathering, and ASTM G154, Cycle 4 (QUVA) testing. This increase correlates directly to an increase in the lifetime of the transparent panel or window in actual use. In QTRAC testing, this increase ranged from 25% (compare Trial #27 to #28) to about 100% (compare Trial #25 to #26). In Florida and Arizona Natural Weathering tests, this increase ranged from about 25% in Florida for Trial #27 and #28 to greater than 50% in both Florida for Trial #25 and #26 and in Arizona (compare Trial #25 with #26 and #27 with #28).

In QUVA testing, the decrease observed for the decay rate of the ultraviolet absorbing molecules when a barrier layer 30 is utilized was measured to be greater than about 27% as shown in Trial #'s 29-32. In each of these trials, the percentage change in the decay rate (ABS/MJ) was obtained by comparing the same system with and without the presence of a barrier layer 30. In Trial #32, the presence of two barrier layers (B1B2) was found to establish the greatest decrease in the decay rate of the ultraviolet absorbing molecules at 71%. In all cases, the thickness of the additive layers for each comparison made in the analysis was comparable.

The application of a barrier layer (B1) increased the abrasion resistance of the additive layers and panel. As shown in Table 6, the abrasion resistance of the additive layers was enhanced by more than 100% for all direct comparisons (see Trial #17 vs. #18, #19 vs. #20, #21 vs. #22, and #23 vs. #24). This example demonstrates that a barrier layer 30 can enhance abrasion resistance.

### EXAMPLE 4

### Barrier Effect: Negation of Color Change

A portion of the panels prepared in Example 1 were exposed to Natural Outdoor Weathering in Florida at an angle of 5° and ASTM G155 Cycle 1 (GMOD) testing. Each panel subjected to weathering in Florida was examined every six months for the occurrence of microcrazing, spontaneous delamination, or adhesion failure using ASTM D3359-92a. Similarly, all panels subjected to GMOD testing were examined for the above mentioned failure modes after every 1.2 MJ/m² of UV exposure. The results obtained for each panel evaluated in this Example is provided in Table 7.

TABLE 7

| | | Failure (years in | | | Failure (years in | | | Failure (MJ/m² |
|---|---|---|---|---|---|---|---|---|
| | | Florida) | | | Florida) | | | in GMOD) |
| #33 | R3 + A2A7 | 2.3 | #35 | R5 + A2A7 | 1.0 | #37 | R6 + A2A7 | 5.36 |
| #34 | R3 + A2A7 + B1 | 2.9 | #36 | R5 + A2A7 + B1 | 3.0 | #38 | R6 + A2A7 + B1 | 10.55 |
| | BARRIER | 26% | | BARRIER | 200% | | BARRIER | 116% |
| | EFFECT | | | EFFECT | | | EFFECT | |

The presence of a barrier layer 30 allows the plastic panel and additive layers to absorb a greater amount of UV radiation prior to reaching the point of failure. This enhancement correlates with an increase in the expected lifetime of the protective layered system or plastic window. A 26% increase in exposure time prior to failure was found for a solar tinted panel having a barrier layer 30 (compare Trial #34 to #33). Similarly, a 116% and 200% increase in exposure time prior to failure was found for a privacy colored panel (compare #38 to #37) and privacy tinted panel (compare #36 to #35), respectively, having a barrier layer 30. This Example demonstrates that one unexpected effect of the barrier layer 30 is to negate any affect of the panel or additive layer color from influencing the lifetime of the component assembly. In other words, the performance of a tinted or colored plastic panel and additive layer combination is normalized when the barrier layer 30 is utilized. The performance of the tinted solar (Trial #34) and tinted privacy (Trial #36) protected layered panels in the presence of a barrier layer 30 was found to both be normalized to a lifetime of approximately 3 years.

A person skilled in the art will recognize from the previous description that modifications and changes can be made to the preferred embodiment of the invention without departing from the scope of the invention as defined by the following claims. A person skilled in the art will further recognize that the measurement of additive rate loss as described in the preferred embodiment are standard measurements that can be obtained by a variety of different test methods. The test methods described in the examples represents only one available method to obtain each of the required measurements.

1. A protected layered system for a component assembly comprising:
a plastic panel; and
at least two protective layers formed integrally with the plastic panel;
one protective layer being a barrier layer that reduces the loss of an additive suspended, and not covalently bonded, in the structure of any underlying protective layer or the plastic panel.

2. The protected layered system of claim 1 wherein the rate of decay at which the additive is lost is limited by the barrier layer to less than about 95% of the decay rate established for the loss of additive in the absence of the barrier layer.

3. The protected layered system of claim 2 wherein the rate of decay at which the additive is lost is limited by the barrier layer to less than about 90% of the decay rate established for the loss of additive in the absence of the barrier layer.

4. The protected layered system of claim 3 wherein the rate of decay at which the additive is lost is limited by the barrier layer to less than about 85% of the decay rate established for the loss of additive in the absence of the barrier layer.

5. The protected layered system of claim 1 wherein the loss of an additive is limited by the barrier layer to less than about 0.8% by volume when exposed to a temperature of about 70° C. for about 500 hours.

6. The protected layered system of claim 1 wherein the loss of an additive is limited by the barrier layer to less than about 0.5% by volume when exposed to a temperature of about 70° C. for about 300 hours.

7. The protected layered system of claim 1 wherein the loss of an additive is limited by the barrier layer to less than about 0.15% by volume when exposed to a temperature of about 70° C. for about 100 hours.

8. The protected layered system of claim 1 wherein the barrier layer reduces the loss of additives with a molecular diameter that is greater than about 150 picometers.

9. The protected layered system of claim 8 wherein the barrier layer reduces the loss of additives with a molecular diameter that is greater than about 200 picometers.

10. The protected layered system of claim 9 wherein the barrier layer reduces the loss of additives with a molecular diameter that is greater than about 300 picometers.

11. The protected layered system of claim 1 wherein the thickness of the barrier layer is between about 1 micrometer and 100 micrometers.

12. The protected layered system of claim 1 wherein the plastic panel is colored, tinted, or a mixture thereof.

13. The protected layered system of claim 12 wherein the barrier layer allows the lifetime of the plastic panel to be substantially similar when the surface temperature of the plastic panel is between about 20° C. and about 120° C.

14. The protected layered system of claim 12 wherein the barrier layer allows the lifetime of the plastic panel to be substantially similar for any colored or tinted plastic panel.

15. The protected layered system of claim 14 wherein the tinted plastic panel is a window assembly having an initial haze level of less than about 1% and an optical transparency of greater than about 20%.

16. The window assembly of claim 15 wherein the change in haze % is less than about 10% after exposure to a 1000 cycle Taber test (CSF10 wheels).

17. The window assembly of claim 16 wherein the change in haze % is less than about 2% after exposure to a 1000 cycle Taber test (CSF10 wheels).

18. The window assembly of claim 15 wherein the optical transparency of the window assembly is greater than about 70%.

19. The window assembly of claim 18 wherein the optical transparency of the window assembly is greater than about 90%.

20. The protected layered system of claim 14 wherein the colored plastic panel is opaque.

21. The protected layered system of claim 1 wherein the amount of UV radiation to which the component assembly is exposed without failure in a GMOD test is more than about 10% greater than the UV radiation exposure limit established for the component assembly in the absence of the barrier layer.

22. The window assembly of claim 1 wherein the amount of UV radiation to which the component assembly is exposed without failure in a QTRAC test is more than about 25% greater than the UV radiation exposure limit established for the component assembly in the absence of the barrier layer.

23. The protected layered system of claim 1 wherein the amount of UV radiation to which the component assembly is exposed without failure in a QUVA test is more than about 40% greater than the UV radiation exposure limit established for the component assembly in the absence of the barrier layer.

24. The protected layered system of claim 1 wherein the amount of UV radiation to which the component assembly is exposed without failure in a natural weathering test is more than about 25% greater than the UV radiation exposure limit established for the component assembly in the absence of the barrier layer.

25. The protected layered system of claim 1 wherein the plastic panel is one selected from the group including polycarbonate resins, acrylic resins, polyarylate resins, polyester resins, polysulfone resins, and mixtures, blends or copolymers thereof.

26. The protected layered system of claim 1 wherein the protective layer is one selected from the group including a coating, a cast film, or an extruded film.

27. The protected layered system of claim 26 wherein the protective layer is one selected from the group of a silicone hard-coat, a polyurethane coating, and an acrylic coating or combinations thereof.

28. The protected layered system of claim 1 wherein the barrier layer is one selected from the group including a conductive material, an inorganic dielectric material, an organic dielectric material, or mixtures and blends thereof.

29. The protected layered system of claim 28 wherein the inorganic dielectric material is one selected from the group including aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, glass, or mixtures and blends thereof.

30. The protected layered system of claim 28 wherein the organic dielectric material is one selected from the group including diamond-like carbon or a dense polymer.

31. The protected layered system of claim 30 wherein the dense polymer is one selected from the group including urethanes, epoxides, acrylates, silicones, or mixtures and blends thereof.

32. The protective layer of claim 1 wherein the additive is one selected from the group including dispersants, surfactants, plasticizers, flow additives, mold release agents, antioxidants, ultraviolet absorbing molecules, IR absorbing pigments, or IR reflecting pigments.

33. The protective layer of claim 32 wherein the ultraviolet absorbing molecule is one selected from the group including derivatives of hydroxybenzophenone, derivatives of polybenzoyl resorcinol, 2-ethylhexyl-2-cyano-3,3-diphenylcycanoacrylate, and mixtures or blends thereof

34. The protective layer of claim 33 wherein the derivative of hydroxybenzophenone or polybenzoylresorcinol is silyated with greater than about 5% of the UVA remaining non-covalently bonded into the structure of the additive layer.

35. The protected layered system of claim 1 wherein the barrier layer is the outermost layer in the protected layered system.

36. The protected layered system of claim 1 wherein the barrier layer is positioned between another protective layer and the plastic panel.

37. The protected layered system of claim 1 wherein the protected layered system includes more than one barrier layer.

38. A protected layered system for a component assembly comprising:
a plastic panel; and
at least one protective layer that is a barrier layer which reduces the loss of an additive suspended, and not covalently bonded, in the structure of the plastic panel.

39. The protected layered system of claim 38 wherein the rate of decay at which the additive is lost is limited by the barrier layer to less than about 95% of the decay rate established for the loss of additive in the absence of the barrier layer.

40. The protected layered system of claim 38 wherein the rate of decay at which the additive is lost is limited by the barrier layer to less than about 90% of the decay rate established for the loss of additive in the absence of the barrier layer.

41. The protected layered system of claim 38 wherein the loss of an additive is limited by the barrier layer to less than about 0.8% by volume when exposed to a temperature of about 70° C. for about 500 hours.

42. The protected layered system of claim 38 wherein the loss of an additive is limited by the barrier layer to less than about 0.5% by volume when exposed to a temperature of about 70° C. for about 300 hours.

43. The protected layered system of claim 38 wherein the loss of an additive is limited by the barrier layer to less than about 0.15% by volume when exposed to a temperature of about 70° C. for about 100 hours.

44. The protected layered system of claim 38 wherein the barrier layer reduces the loss of additives with a molecular diameter that is greater than about 150 picometers.

45. The protected layered system of claim 38 wherein the thickness of the barrier layer is between about 1 micrometer and 100 micrometers.

46. The protected layered system of claim 38 wherein the plastic panel is colored, tinted, or a mixture thereof.

47. The protected layered system of claim 46 wherein the barrier layer allows the lifetime of the plastic panel to be substantially similar for any colored or tinted plastic panel.

48. The protected layered system of claim 47 wherein the tinted plastic panel is a window assembly having an initial haze level of less than 1% and an optical transparency of greater than about 20%.

49. The protected layered system of claim 48 wherein the percentagage change in haze is less than about 10% after exposure to a 1000 cycle Taber test (CSF10 wheels).

50. The protected layered system of claim 48 wherein the optical transparency of the window assembly is greater than about 70%.

51. The protected layered system of claim 47 wherein the colored plastic panel is opaque.

52. The protected layered system of claim 38 wherein the amount of UV radiation to which the component assembly is exposed without failure in a GMOD test is more than about 10% greater than the UV radiation exposure limit established for the window assembly in the absence of the barrier layer.

53. The protected layered system of claim 38 wherein the amount of UV radiation to which the component assembly is exposed without failure in a QTRAC test is more than about 25% greater than the UV radiation exposure limit established for the component assembly in the absence of the barrier layer.

54. The protected layered system of claim 38 wherein the amount of UV radiation to which the component assembly can be exposed without failure in a QUVA test is more than about 40% greater than the UV radiation exposure limit established for the component assembly in the absence of the barrier layer.

55. The protected layered system of claim 38 wherein the amount of UV radiation to which the component assembly can be exposed without failure in a natural weathering test is more than about 25% greater than the UV radiation exposure limit established for the component assembly in the absence of the barrier layer.

56. The protected layered system of claim 38 wherein the plastic panel is one selected from the group including polycarbonate resins, acrylic resins, polyarylate resins, polyester resins, polysulfone resins, and mixtures, blends or copolymers thereof.

57. The protected layered system of claim 38 wherein the barrier layer is one selected from the group including a conductive material, an inorganic dielectric material, an organic dielectric material, or mixtures and blends thereof.

58. The protected layered system of claim 38 wherein the inorganic dielectric material is one selected from the group including aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, glass, or mixtures and blends thereof.

59. The protected layered system of claim 38 wherein the additive is one selected from the group including dispersants, surfactants, plasticizers, flow additives, mold release agents, antioxidants, ultraviolet absorbing molecules, IR absorbing pigments, or IR reflecting pigments.
